(19) United States
(12) Patent Application Publication
(10) Pub. No.: US 2026/0167144 A1
(43) Pub. Date: Jun. 18, 2026

(54) VEHICLE, VEHICLE SERVICE PROVIDING SYSTEM INCLUDING SAME, AND VEHICLE SERVICE PROVIDING METHOD THEREOF

(71) Applicants: Hyundai Motor Company, Seoul (KR); Kia Corporation, Seoul (KR)

(72) Inventor: Tae Kyu Kim, Hwaseong-si (KR)

(21) Appl. No.: 19/229,652

(22) Filed: Jun. 5, 2025

(30) Foreign Application Priority Data
Dec. 18, 2024 (KR) 10-2024-0190258

(51) Int. Cl. B60R 25/01; B60K 35/22

(52) U.S. Cl. CPC B60R 25/01; B60K 35/22; B60K 2360/16; B60K 2360/589; B60R 2325/40

(57) ABSTRACT

In an embodiment a vehicle includes a digital key controller and a vehicle terminal configured to send a request message to a connected car service server requesting whether a connected car account is linked to a profile selected from a user profile list, to send a request message from the digital key controller requesting whether a digital key linked to the selected profile is registered and to display a linkage guidance message requesting registration of whichever of the connect car account and the digital key is not linked to the selected profile.

### CROSS-REFERENCE TO RELATED APPLICATIONS

This application claims priority of Korean Application No. 10-2024-0190258, filed on December 18, 2024, which application is hereby incorporated herein by reference.

### TECHNICAL FIELD

The present disclosure relates to a vehicle and, more particularly, to a vehicle configured to enable a user to use both a connected car service and a digital key service, a vehicle service provision system including the same, and a vehicle service provision method thereof.

### BACKGROUND

Recently, vehicles are being configured to provide various services, based on communication with a server connected through a communication network, and such vehicles are also called a connected car, a smart vehicle, or an intelligent vehicle.

Further, a digital key service of registering a digital key in a portable terminal instead of a physical key to unlock/start a vehicle is being implemented.

Since a connected car service and the digital key service are provided as separate functions, there is a case where a user uses only one service.

Therefore, a method would be desirable that allows a user to use either one of the connected car service and the digital key service.

The foregoing described as the background art is intended merely to aid in the understanding of the background of the present disclosure, and is not intended to mean that the present disclosure falls within the purview of the related art already known to those skilled in the art.

### SUMMARY

Embodiments provide a vehicle configured to enable a user to use both a connected car service and a digital key service, a vehicle service provision system including the same, and a vehicle service provision method thereof.

Embodiments provide a vehicle configured to guide a user to also use one of a connected car service and a digital key service when the user uses only the other service thereof, a vehicle service provision system including the same, and a vehicle service provision method thereof.

Embodiments provide a vehicle capable of providing both a connected car service and a digital key service, a vehicle service provision system including the same, and a vehicle service provision method thereof.

Embodiments may not be limited to the above-mentioned embodiments, and other embodiments, which are not mentioned, may be clearly understood from the following descriptions by those skilled in the .

Embodiments provide a vehicle with a vehicle terminal and a digital key controller, wherein the vehicle terminal may be configured to request whether a connected car account is linked from a connected car service server in relation to a profile selected from a user profile list, request whether a digital key linked to the selected profile is registered from the digital key controller, and display a linkage guidance message of one of the connected car account and the digital key when only the other thereof is linked to the selected profile.

According to an embodiment of the present disclosure, the vehicle terminal may be configured to display a digital key service linkage guidance message when receiving an account linkage success message from the connected car service server and receiving a digital key non-registration message from the digital key controller.

According to an embodiment of the present disclosure, the vehicle terminal may be configured to display a connected car service linkage guidance message when receiving an account linkage failure message from the connected car service server and receiving a digital key registration message from the digital key controller.

According to an embodiment of the present disclosure, the vehicle terminal may be further configured to transmit the connected car service linkage guidance message to a user terminal.

According to an embodiment of the present disclosure, the vehicle terminal may include: a first communication module configured to communicate with the connected car service server; a second communication module configured to communicate with the digital key controller; a user interface configured to display a connected car service linkage guidance message or a digital key service linkage guidance message; and a processor configured to request whether the connected car account is linked from the connected car service server, request whether the digital key is registered from the digital key controller, and output the connected car service linkage guidance message or the digital key service linkage guidance message to the user interface, based on responses transmitted from the connected car service server and the digital key controller after a request.

A vehicle service provision system according to an embodiment of the present disclosure may include: a vehicle terminal mounted in a vehicle; a digital key controller mounted in the vehicle; and a connected car service server configured to provide a connected car service, wherein the vehicle terminal may be configured to request whether a connected car account is linked from the connected car service server in relation to a profile selected from a user profile list, request whether a digital key linked to the selected profile is registered from the digital key controller, and display a linkage guidance message of one of the connected car account and the digital key when only the other thereof is linked to the selected profile.

According to an embodiment of the present disclosure, the vehicle terminal may be configured to display a digital key service linkage guidance message when receiving an account linkage success message from the connected car service server and receiving a digital key non-registration message from the digital key controller.

According to an embodiment of the present disclosure, the vehicle terminal may be configured to display a connected car service linkage guidance message when receiving an account linkage failure message from the connected car service server and receiving a digital key registration message from the digital key controller.

According to an embodiment of the present disclosure, the vehicle terminal may be further configured to transmit the connected car service linkage guidance message to a user terminal.

A vehicle service provision method according to an embodiment of the present disclosure may include: requesting, by a vehicle module, whether a connected car account is linked from a connected car service server and requesting whether a digital key is registered from a digital key controller in relation to a profile selected from a user profile list; receiving, by the vehicle module, responses transmitted from the connected car service server and the digital key controller; and displaying, by the vehicle module, a connected car service linkage guidance message or a digital key service linkage guidance message, based on the received responses.

According to an embodiment of the present disclosure, the displaying may include displaying, by the vehicle module, the digital key service linkage guidance message when the receiving comprises receiving an account linkage success message from the connected car service server and receiving a digital key non-registration message from the digital key controller.

According to an embodiment of the present disclosure, the displaying may include displaying, by the vehicle module, the connected car service linkage guidance message when the receiving comprises receiving an account linkage failure message from the connected car service server and receiving a digital key registration message from the digital key controller.

According to an embodiment of the present disclosure, the vehicle service provision method may further include transmitting, by the vehicle module, the connected car service linkage guidance message to a user terminal.

In addition to the above-mentioned solutions to the technical subjects, detailed particulars according to various embodiments of the present disclosure are included in the following description and the accompanying drawings.

According to an embodiment of the present disclosure, there may be provided a vehicle configured to enable a user to use both a connected car service and a digital key service, a vehicle service provision system including the same, and a vehicle service provision method thereof.

According to an embodiment, when a user uses only one of a connected car service and a digital key service, a vehicle or a vehicle terminal may guide the user to also use the other service.

According to an embodiment, a vehicle may provide both a connected car service and a digital key service. Therefore, a user may usefully use different types of vehicle services, and the convenience of the user may be improved.

Advantageous effects obtainable from the present disclosure may not be limited to the above-mentioned effects, and other effects which are not mentioned may be clearly understood from the following descriptions by those skilled in the art to which the present disclosure pertains.

### BRIEF DESCRIPTION OF THE DRAWINGS

The accompanying drawings are intended to aid understanding of embodiments of the present disclosure, and provide embodiments along with a detailed description. However, the technical features of the embodiments are not limited to specific drawings, and features disclosed in the respective drawings may be combined to form a new embodiment.

FIG. 1 illustrates an example of a configuration of a vehicle service provision system including a vehicle according to an embodiment of the present disclosure;

FIG. 2 illustrates an example of a configuration of a vehicle terminal according to an embodiment of the present disclosure;

FIG. 3 illustrates an example of a vehicle service provision method according to an embodiment of the disclosure;

FIG. 4 illustrates another example of a vehicle service provision method according to an embodiment of the disclosure;

FIG. 5 illustrates an operation of a vehicle terminal in a vehicle service provision method according to an embodiment of the present disclosure;

FIG. 6 illustrates a screen on which a vehicle terminal displays a connected car service linkage guidance message M1 according to an embodiment of the present disclosure; and

FIG. 7 illustrates a screen on which a user terminal displays a connected car service linkage guidance message M2 according to an embodiment of the present disclosure.

### DETAILED DESCRIPTION OF ILLUSTRATIVE EMBODIMENTS

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure.

Terms including an ordinal number such as "a first" and "a second" may be used to describe various elements, but the elements are not limited to the terms. The above terms are used merely for the purpose of distinguishing one element from other elements.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

For purposes of present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, and C", "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

The terms "module" and "unit" used for the elements in the following description are given or interchangeably used in consideration of only the ease of writing the specification, and do not have distinct meanings or roles by themselves.

In the case where an element is referred to as being "connected" or "coupled" to any other elements, it should be understood that not only the element may be directly connected or coupled to the other elements, but also another element may exist therebetween. Contrarily, in the case where an element is referred to as being "directly connected" or "directly coupled" to any other element, it should be understood that no other element exists therebetween.

Hereinafter, embodiments set forth herein will be described in detail with reference to the accompanying drawings, and the same or similar elements are given the same and similar reference numerals regardless of figure numbers, so duplicate descriptions thereof will be omitted.

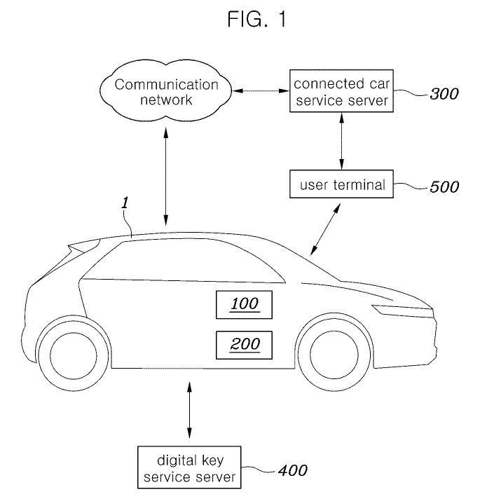

FIG. 1 illustrates an example of a configuration of a vehicle service provision system including a vehicle 1 according to an embodiment of the present disclosure.

Referring to FIG. 1, the vehicle service provision system may include a vehicle terminal 100 and a digital key controller 200 mounted in a vehicle 1, a connected car service server 300, and a digital key service server 400, but the configuration of the vehicle service provision system is not limited thereto.

For example, the vehicle service provision system may further include a user terminal 500, and the user terminal 500 may perform account registration and login in association with the connected car service server 300.

According to an embodiment of the present disclosure, it is possible to achieve a technical aspect of notifying linkage (or registration) for one of a connected car service and a digital key service when a user uses the other service thereof.

The vehicle terminal 100 may communicate with the connected car service server 300, based on a preset communication network.

For example, the communication network may employ a wireless Internet technology, such as a wireless LAN (WLAN) (Wi-Fi), wireless broadband (WiBro), and/or World Interoperability for Microwave Access (WiMAX), and/or a mobile communication technology, such as code-division multiple access (CDMA), global system for mobile communication (GSM), Long-Term Evolution (LTE), LTE-Advanced, and/or International Mobile Telecommunication (IMT)-2020.

For example, the vehicle terminal 100 may implement an in-vehicle infotainment (IVI) system.

According to an embodiment, the vehicle terminal 100 may store at least one piece of user information, and may manage the user information in the form of a profile.

When a profile other than a guest profile is selected by the user or when the vehicle terminal 100 automatically selects (logs in to) the profile, the vehicle terminal 100 may request linkage of a connected car account from the connected car service server 300, based on user information related to the profile selected or logged into.

According to an embodiment, when login to the connected car service server 300 is successful with the connected car account linked to the user information, the vehicle terminal 100 may receive an account linkage success message from the connected car service server 300.

According to an embodiment, when the connected car account linked to the user information is not stored in the connected car service server 300 or login information is incorrect, the vehicle terminal 100 may receive an account linkage failure message from the connected car service server 300.

When the user logs in, the vehicle terminal 100 may request the digital key controller 200 to determine whether a digital key is linked (or registered), based on user information related to the user logged-in.

According to an embodiment, when a digital key linked to the user information is linked (or registered) in the digital key controller 200, the vehicle terminal 100 may receive a digital key registration message from the digital key controller 200.

According to an embodiment, when the digital key linked to the user information is not registered in the digital key controller 200, the vehicle terminal 100 may receive a digital key non-registration message from the digital key controller 200.

The vehicle terminal 100 may output a service linkage guidance message, or transmit a service linkage guidance message to the user terminal 500, based on a response from the connected car service server 300 and a response from the digital key controller 200.

According to an embodiment, when receiving the account linkage success message from the connected car service server 300 and receiving the digital key non-registration message from the digital key controller 200, the vehicle terminal 100 may output a digital key service linkage guidance message.

According to an embodiment, when receiving the account linkage failure message from the connected car service server 300 and receiving the digital key registration message from the digital key controller 200, the vehicle terminal 100 may output a connected car service linkage guidance message, or transmit a connected car service linkage guidance message to the user terminal 500, based on previously registered user information.

According to an embodiment, the vehicle terminal 100 may determine that the linkage of the account has failed when the account of the user is not registered or the profile of the user is not selected.

Accordingly, when the digital key is linked to the connected car service server 300 in a state in which the account of the user is not registered in the vehicle terminal 100 or the profile of the user is not selected, the vehicle terminal 100 may display the connected car service linkage guidance message through a user interface 130, or may transmit the same to the user terminal 500.

That is, when only one of the connected car account and the digital key of the user is linked, the vehicle terminal 100 may output a registration notification message of the other one or transmit the same to the user terminal 500.

The connected car service server 300 may process registration of the user in association with the user terminal 500, and may provide the connected car service to the vehicle 1 registered by the user.

When receiving a request to link the connected car account with the user information from the vehicle terminal 100, the connected car service server 300 may identify whether the connected car account corresponding to the user information is registered.

According to an embodiment, when the connected car account corresponding to the user information is registered, the connected car service server 300 may transmit an account linkage success message to the vehicle terminal 100 in response to the request from the vehicle terminal 100.

When the account is successfully linked, the connected car service server 300 may provide a connected car service corresponding to the account to the vehicle terminal 100.

According to an embodiment, when the connected car account corresponding to the user information is not registered, the connected car service server 300 may transmit an account linkage failure message to the vehicle terminal 100.

The digital key controller 200 may perform door unlocking/starting of the linked vehicle.

According to an embodiment, when receiving a request to identify whether the digital key is registered together with the user information from the vehicle terminal 100, the digital key controller 200 may identify whether the digital key corresponding to the user information is registered.

When the digital key corresponding to the user information is registered, the digital key controller 200 may transmit a digital key registration message to the vehicle terminal 100.

When the digital key corresponding to the user information is not registered, the digital key controller 200 may transmit a digital key non-registration message to the vehicle terminal 100.

The digital key service server 400 may register a user who wishes to use a digital key service, may generate a digital key for the registered user, and may provide the digital key service.

The user terminal 500 may perform account registration and login in association with the connected car service server 300, and may link to the vehicle terminal 100.

For example, the user terminal 500 may receive a connected car service linkage guidance message from the vehicle terminal 100, and may display the received connected car service linkage guidance message.

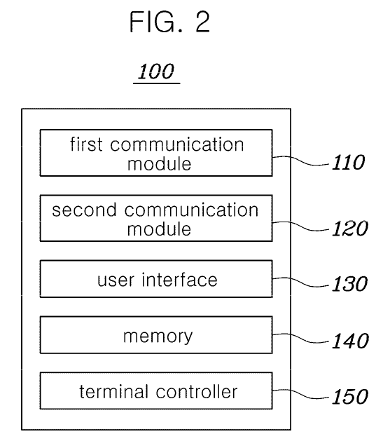

FIG. 2 illustrates an example of the configuration of a vehicle terminal 100 according to an embodiment of the present disclosure.

Referring to FIG. 1 and FIG. 2, the vehicle terminal 100 may include at least one communication module 110 and 120, a user interface 130, a memory 140, and a terminal controller 150, but the configuration of the vehicle terminal 100 is not limited thereto.

A first communication module 110 may include a communication circuit configured to communicate with the connected car service server 300 through a communication network. In addition, the first communication module 110 may include a communication circuit configured to communicate with a user terminal 500 through the communication network.

A second communication module 120 may include a communication circuit configured to communicate with the digital key controller 200, based on a preset communication protocol.

In the present embodiment, the vehicle terminal 100 includes two communication modules 110 and 120, but is not limited thereto.

The user interface 130 may be configured to receive an input of a user. For example, the user interface 130 may comprise a graphical user interface (GUI). For example, the user interface 130 may display a user setting menu (USM).

According to an embodiment, the user interface 130 may display a list of user profiles previously registered in the vehicle terminal 100, and may transmit a user profile selected from the user list to the terminal controller 150.

The user interface 130 may display a message provided from the terminal controller 150. For example, the user interface 130 may display a connected car service linkage guidance message.

The memory 140 may store an algorithm (or program, software, or an application), data, and the like for performing an operation of the vehicle terminal 100.

For example, the memory 140 may be configured as at least one storage medium among storage media (or recording media), such as a flash memory, a hard disk, a secure digital (SD) card, a random-access memory (RAM), a static random-access memory (SRAM), a read-only memory (ROM), a programmable read-only memory (PROM), an electrically erasable and programmable ROM (EEPROM), an erasable and programmable ROM (EPROM), a register, a removable disk, and a web storage.

The terminal controller 150 may perform the overall operation of the vehicle terminal 100, and may provide a vehicle service by operating based on an algorithm/data stored in the memory 140.

The terminal controller 150 may be a data processing device configured as hardware having a circuit with a physical structure for executing desired operations. For example, the desired operations may include a code or instructions included in the program.

For example, the data processing device configured as the hardware may include a microprocessor, a central processing unit, a processor core, a multi-core processor, a multiprocessor, an application-specific integrated circuit (ASIC), or a field programmable gate array (FPGA).

According to an embodiment, when the user logs in, that is, when a user profile is selected from the list of user profiles displayed on the user interface 130, the terminal controller 150 may request linkage of a connected car account from the connected car service server 300, based on user information. Here, the user profile may be prepared with a plurality of slots (lists) in the vehicle terminal 100, and may generally include a plurality of user profiles and one guest profile. A profile may be selected (logged in) through the user interface 130 of the vehicle terminal 100 when a vehicle is key-on, or a user profile may be linked to each smart key (FOB) and automatically selected according to the smart key detected in the vehicle. Each user profile except the guest profile may be linked to one connected car service account and one digital key.

When the user logs in, i.e., when the user profile is selected from the list of user profiles displayed on the user interface 130, the terminal controller 150 may request whether a digital key is registered from the digital key controller 200, based on the user information.

According to an embodiment, the terminal controller 150 may output a service linkage guidance message through the user interface 130, or transmit a service linkage guidance message to the user terminal 500, based on a response from the connected car service server 300 and a response from the digital key controller 200.

For example, when receiving an account linkage success message from the connected car service server 300 and receiving a digital key non-registration message from the digital key controller 200, the terminal controller 150 may output a digital key service linkage guidance message through the user interface 130.

For example, when receiving an account linkage failure message from the connected car service server 300 and receiving a digital key registration message from the digital key controller 200, the terminal controller 150 may output a connected car service linkage guidance message through the user interface 130, or transmit a connected car service linkage guidance message to the user terminal 500, based on previously registered user information.

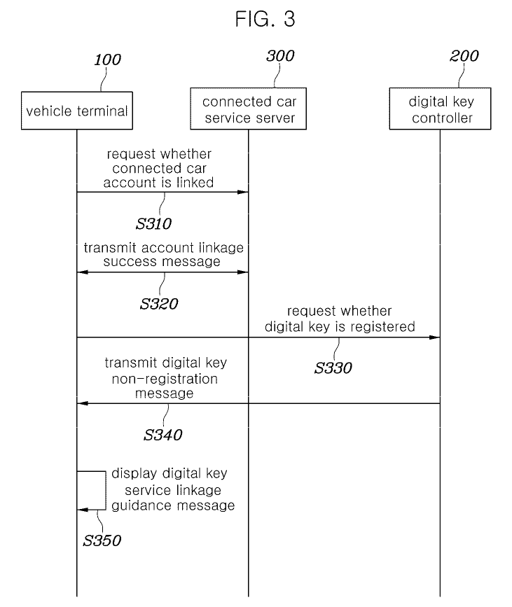

FIG. 3 illustrates an example of a vehicle service provision method according to an embodiment of the disclosure.

FIG. 3 shows a case in which a user is able to use a connected car service but is not able to use a digital key service.

Referring to FIG. 3, when the user logs in, i.e., when a user profile is selected from a user profile list displayed on a user interface 130, a vehicle terminal 100 may request information from a connect car service 300 whether a connected car account is linked to the user profile based on user information (operation S310).

When receiving a request for whether the connected car account is linked, the connected car service server 300 may identify whether the connected car account corresponding to the user information is registered, and may transmit an account linkage success message to the vehicle terminal 100 when the connected car account corresponding to the user information is registered (operation S320).

When the user logs in, i.e., when the user profile is selected from the user profile list displayed on the user interface 130, the vehicle terminal 100 may request information from the digital key controller 200 whether a digital key is registered to the user profile based on the user information (operation S330).

When receiving a request for whether the digital key is registered, the digital key controller 200 may identify whether the digital key corresponding to the user information is registered, and may transmit a digital key non-registration message to the vehicle terminal 100 when the digital key corresponding to the user information is not registered (operation S340).

When receiving the account linkage success message from the connected car service server 300 and receiving the digital key non-registration message from the digital key controller 200, the vehicle terminal 100 may display a digital key service linkage guidance message through the user interface 130 (operation S350).

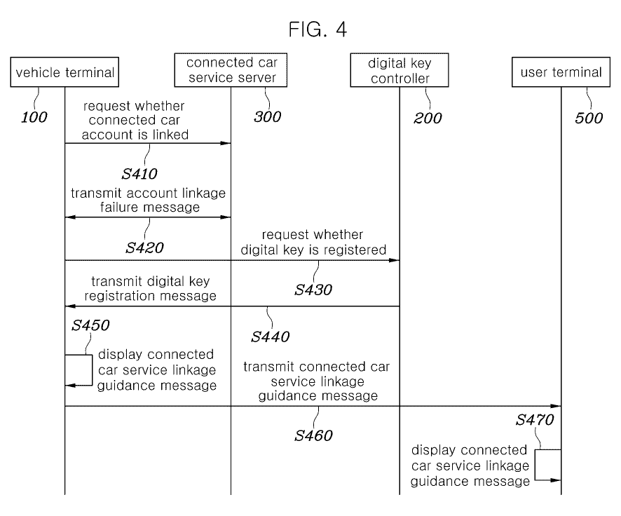

FIG. 4 illustrates another example of a vehicle service provision method according to an embodiment of the disclosure.

FIG. 4 shows a case in which a user is able to use a digital key service but is not able to use a connected car service.

Referring to FIG. 4, when the user logs in, i.e., when a user profile is selected from a user profile list displayed on a user interface 130, a vehicle terminal 100 may request information from a connected car service server 300 whether a connected car account is linked based on user information (operation S410).

When receiving a request for whether the connected car account is linked, the connected car service server 300 may identify whether the connected car account corresponding to the user information is registered, and may transmit an account linkage failure message to the vehicle terminal 100 when the connected car account corresponding to the user information is not registered (operation S420).

When the user logs in, i.e., when the user profile is selected from the user profile list displayed on the user interface 130, the vehicle terminal 100 may request information from the digital key controller 200 whether a digital key is registered based on the user information (operation S430).

When receiving a request for whether the digital key is registered, the digital key controller 200 may identify whether the digital key corresponding to the user information is registered, and may transmit a digital key registration message to the vehicle terminal 100 when the digital key corresponding to the user information is registered (operation S440).

When receiving the account linkage failure message from the connected car service server 300 and receiving the digital key registration message from the digital key controller 200, the vehicle terminal 100 may display a connected car service linkage guidance message through the user interface 130 (operation S450).

In addition, the vehicle terminal 100 may transmit the connected car service linkage guidance message to the user terminal 500 (operation S460). Accordingly, the user terminal 500 may display the connected car service linkage guidance message (operation S470).

For example, the vehicle terminal 100 may determine that a linkage of the account has failed when the account of the user is not registered in the vehicle terminal 100 or the user profile is not selected.

Accordingly, when the digital key is linked to the connected car service server 300 in a state in which the account of the user is not registered in the vehicle terminal 100 or the profile of the user is not selected, the vehicle terminal 100 may output the connected car service linkage guidance message through the user interface 130, or may transmit the same to the user terminal 500.

That is, when only one of the connected car account and the digital key of the user is linked, the vehicle terminal 100 may output a linkage guidance message of the other one or transmit the same to the user terminal 500.

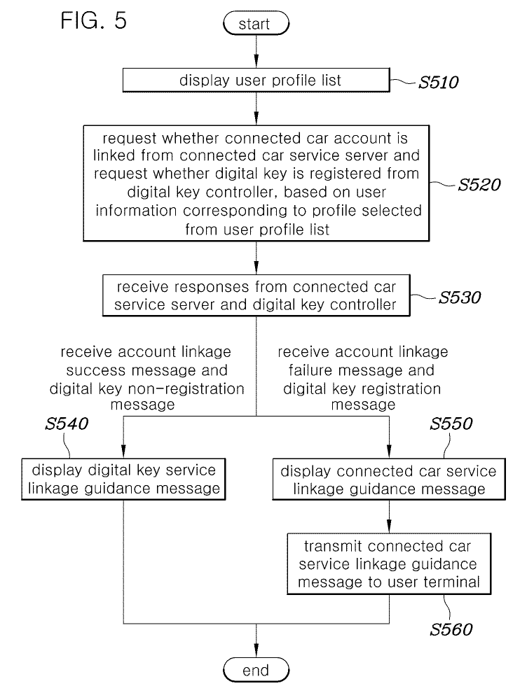

FIG. 5 illustrates an operation of a vehicle terminal 100 in a vehicle service provision method according to an embodiment of the present disclosure.

Referring to FIG. 5, the vehicle terminal 100 may display a user profile list (operation S510), and may request information whether a connected car account is linked from a connected car service server 300 and request information whether a digital key is registered from a digital key controller 200, based on user information corresponding to a profile selected from the user profile list (operation S520).

The vehicle terminal 100 may receive responses from the connected car service server 300 and the digital key controller 200 (operation S530).

When receiving an account linkage success message and a digital key non-registration message as the responses, the vehicle terminal 100 may display a digital key service linkage guidance message (operation S540).

When receiving an account linkage failure message and a digital key registration message as the responses, the vehicle terminal 100 may display a connected car service linkage guidance message (operation S550), and may transmit the connected car service linkage guidance message to the user terminal 500 (operation S560).

According to an embodiment of the present disclosure, when a user is using only one of a connected car service and a digital key service, a vehicle 1 or the vehicle terminal 100 may guide the user to use the other service.

Therefore, the user may use different types of vehicle services, and the convenience for the user may be improved.

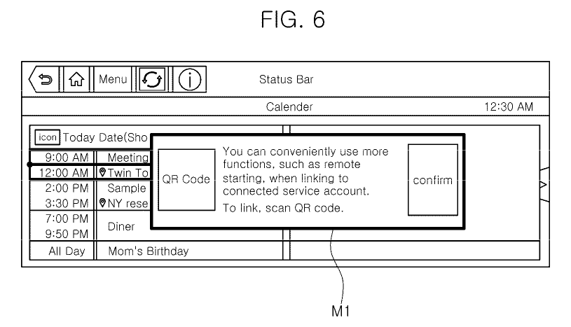

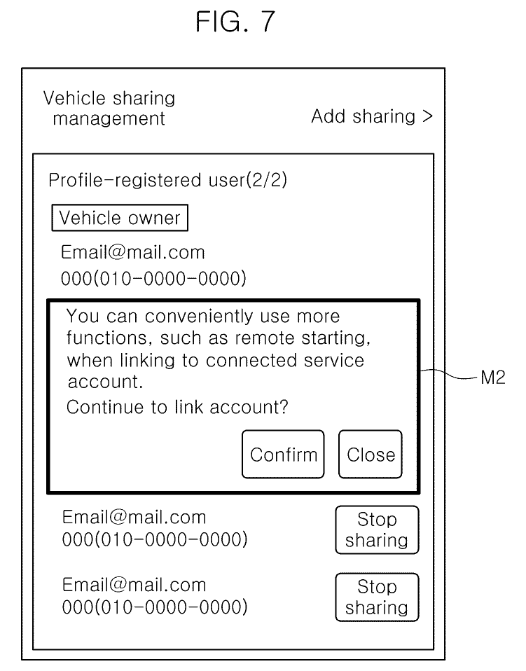

FIG. 6 illustrates a screen on which a vehicle terminal 100 displays a connected car service linkage guidance message M1 according to an embodiment of the present disclosure, and FIG. 7 illustrates a screen on which a user terminal 500 displays a connected car service linkage guidance message M2 according to an embodiment of the present disclosure.

When the vehicle terminal 100 or the user terminal 500 displays the guidance messages M1 and M2, the user may easily register for a service according to the guidance messages M1 and M2, thus improving the usefulness and convenience of the vehicle service.

In an embodiment of the present disclosure, to perform a function, a connected car service server 300 and a digital key service server 400 may include at least one communication module, at least one memory/storage that stores an algorithm (or software or program), data required to perform the algorithm, and information generated or obtained according to an operation, and at least one processor.

For example, the processor may be a data processing device configured as hardware having a circuit with a physical structure for executing desired operations. For example, the desired operations may include a code or instructions included in a program.

For example, the data processing device configured as hardware may include a microprocessor, a central processing unit, a processor core, a multi-core processor, a multiprocessor, an application-specific integrated circuit (ASIC), or a field programmable gate array (FPGA).

For example, the memory/storage may be configured as at least one storage medium (or recording medium) among storage media, such as a flash memory, a hard disk, a secure digital (SD) card, a random-access memory (RAM), a static random-access memory (SRAM), a read-only memory (ROM), a programmable read-only memory (PROM), an electrically erasable and programmable ROM (EEPROM), an erasable and programmable ROM (EPROM), a register, a removable disk, and a web storage.

Although embodiments of the present disclosure have been described above with reference to the accompanying drawings, the present disclosure is not necessarily limited to these embodiments and various modifications and changes may be made thereto without departing from the technical idea of the present disclosure. Therefore, the embodiments set forth herein are not intended to limit the technical idea of the present disclosure but intended to explain the technical idea of the present disclosure, and the scope of the technical idea of the present disclosure is not limited by these embodiments. Accordingly, the embodiments as described above should be construed as being illustrative and non- limitative in all aspects. The scope of protection of the present disclosure should be de fined by the appended claims, and all technical ideas equivalent to the claims shall be construed as falling within the scope of protection of the present disclosure.

What is claimed is:

1. A vehicle comprising:
a digital key controller; and
a vehicle terminal configured to:
send a request message to a connected car service server requesting whether a connected car account is linked to a profile selected from a user profile list;
send a request message to the digital key controller requesting whether a digital key linked to the selected profile is registered ; and
display a linkage guidance message requesting registration of whichever of the connect car account and the digital key is not linked to the selected profile.

2. The vehicle of claim 1, wherein the vehicle terminal is configured to display a digital key service linkage guidance message as the linkage guidance message based on receiving an account linkage success message from the connected car service server and receiving a digital key non-registration message from the digital key controller.

3. The vehicle of claim 1, wherein the vehicle terminal is configured to display a connected car service linkage guidance message as the linkage guidance message based on receiving an account linkage failure message from the connected car service server and receiving a digital key registration message from the digital key controller.

4. The vehicle of claim 3, wherein the vehicle terminal is further configured to transmit the connected car service linkage guidance message to a user terminal.

5. The vehicle of claim 1, wherein the vehicle terminal comprises:
a first communication module configured to communicate with the connected car service server;
a second communication module configured to communicate with the digital key controller;
a user interface configured to display a connected car service linkage guidance message or a digital key service linkage guidance message; and
a processor configured to request the information from the connect car service server whether the connected car account is linked, request the information from the digital key controller whether the digital key is registered, and output the connected car service linkage guidance message or the digital key service linkage guidance message on the user interface, based on response messages received from the connected car service server and the digital key controller.

6. The vehicle of claim 1, wherein the vehicle terminal is configured to automatically select the user profile from the user profile list based on detection of a smart key in the vehicle.

7. The vehicle of claim 1, wherein the vehicle terminal is configured to:
display the user profile list when the vehicle is powered on;
receive a selection of the user profile by a user; and
request the information whether the connected car account is linked and the information whether the digital key is registered in response to the user’s selection of the profile.

8. A system comprising:
a vehicle terminal mounted in a vehicle;
a digital key controller mounted in the vehicle; and
a connected car service server configured to provide a connected car service,
wherein the vehicle terminal is configured to:
send a request message to the connected car service requesting whether a connected car account is linked to a profile selected from a user profile list;
send a request message to the digital key controller requesting whether a digital key linked to the selected profile is registered; and
display a linkage guidance message requesting registration of whichever of the connect car account and the digital key is not linked to the selected profile.

9. The system of claim 8, wherein the vehicle terminal is configured to display a digital key service linkage guidance message as the linkage guidance message based on receiving an account linkage success message from the connected car service server and receiving a digital key non-registration message from the digital key controller.

10. The system of claim 8, wherein the vehicle terminal is configured to display a connected car service linkage guidance message as the linkage guidance message based on receiving an account linkage failure message from the connected car service server and receiving a digital key registration message from the digital key controller.

11. The system of claim 10, wherein the vehicle terminal is further configured to transmit the connected car service linkage guidance message to a user terminal.

12. The system of claim 8, wherein the vehicle terminal is configured to automatically select the user profile from the user profile list based on detection of a smart key in the vehicle.

13. The system of claim 8, wherein the vehicle terminal is configured to:
display the user profile list when the vehicle is powered on;
receive a selection of the user profile by a user; and
request the information whether the connected car account is linked and the information whether the digital key is registered in response to the user’s selection of the profile.

14. A method comprising:
sending a request message, by a vehicle module to a connected car service server, requesting whether a connected car account is linked to a profile selected from a user profile list;
sending a request message, by the vehicle module to a digital key controller, requesting whether a digital key is registered with respect to the selected profile;
receiving, by the vehicle module, response message from the connected car service server and the digital key controller; and
displaying, by the vehicle module, a connected car service linkage guidance message or a digital key service linkage guidance message based on the received response messages.

15. The method of claim 14, wherein the displaying comprises displaying, by the vehicle module, the digital key service linkage guidance message based on the receiving comprises receiving an account linkage success message from the connected car service server and receiving a digital key non-registration message from the digital key controller.

16. The method of claim 14, wherein the displaying comprises displaying, by the vehicle module, the connected car service linkage guidance message based on the receiving comprises receiving an account linkage failure message from the connected car service server and receiving a digital key registration message from the digital key controller.

17. The method of claim 16, further comprising transmitting, by the vehicle module, the connected car service linkage guidance message to a user terminal.

18. The method of claim 14, further comprising transmitting, by the vehicle module, the connected car service linkage guidance message to a user terminal.

19. The method of claim 14, further comprising automatically selecting the user profile from the user profile list based on detection of a smart key in the vehicle.

20. The method of claim 14,
wherein the user profile list is displayed when the vehicle is powered on,
wherein a selection of the user profile by a user is received, and
wherein the information whether the connected car account is linked and the information whether the digital key is registered is requested in response to the user’s selection of the profile.
